(19) United States
(12) Patent Application Publication
(10) Pub. No.: US 2009/0315841 A1
(43) Pub. Date: Dec. 24, 2009

(54) Touchpad Module which is Capable of Interpreting Multi-Object Gestures and Operating Method thereof

(76) Inventors: Chien-Wei Cheng, Hsin-Chu City (TW); Wei-Wen Yang, Hsin-Chu City (TW); Ming-Chieh Tsai, Hsin-Chu City (TW); Ji-Han Liu, Hsin-Chu City (TW)

Correspondence Address: LanWay IPR Services, P.O. box 223205, Chantilly, VA, 20153, US

(21) Appl. No.: 12/393,217

(22) Filed: Feb. 26, 2009

Related U.S. Application Data
(60) Provisional application No. 61/074,144, filed on Jun. 20, 2008.

(51) Int. Cl. G06F 3/041; G06F 3/033

(52) U.S. Cl. 345/173; 715/863

(57) ABSTRACT

A touchpad module, capable of interpreting multi-object gestures and an operating method, includes a detecting element for detecting an object amount and gesture made from a conductive object placed on the touchpad surface and a processing element for interpreting and driving a corresponding simulation such as a mouse, a keyboard or a hot-key simulation and thus controlling a change of document, icon, picture or frame displayed on a display. Accordingly, the touchpad and the operating method thereof detect and interpret multi-object gestures so that it may simulate the input operation with the input devices such as a mouse and a keyboard and the selection of hot-key functions provided by various application programs.

### CROSS-REFERENCE

This application claims priority from U.S. Provisional Patent Application No. 61/074,144, filed on Jun. 20, 2008.

### BACKGROUND

The present invention relates to a touchpad module and operating method thereof, and more specifically, to the touchpad module which is capable of interpreting multi-object gestures and operating method thereof.

The touchpad has become a standard configuration of various consumer electronic products and computer device, however, the single-finger touchpad seems unsatisfied the user demand on direct operation nowadays. Accordingly, how to enrich the function of touch interface is the trend of the touch sensing technique development. In order to fulfill mentioned user's demand, effective and rapid identification method and device of the touchpad module to the multi-object gestures such as U.S. Pat. Nos. 5,825,352 and 5,920,309 are required. Also, the touchpad module having the ability in interpreting the meaning of the multi-object gestures and then driving corresponding application programs mounted on an operating system such as ACDsee, Adobe Acrobat and Microsoft office package is needed. Therefore, keeping on developing touchpad module having the advanced gesture supporting and interpreting technique is desired.

### BRIEF SUMMARY

It is therefore the objective of the present invention to provide a touchpad module which is capable of interpreting multi-object gestures for user to operate using multi-object gestures instead of the input devices such as a mouse or a keyboard.

It is further the objective of the present invention to provide an operating method of a touchpad module which is capable of detecting and interpreting multi-object gestures to simulate the input operation of a computer system performed through the input devices such as the mouse or the keyboard so that an user may control a change of a document, icon, picture or frame displayed on a display via direct operation of the touchpad module.

In accordance with the claimed invention, the touchpad module includes a detecting element for detecting an object amount and a gesture made from a conductive object placed on a touchpad surface, and a processing element for interpreting and driving a corresponding simulation according to the object amount and the gesture to control a change of a document, icon, picture or frame displayed on a display. The corresponding simulation is a mouse simulation, a keyboard simulation or a hot-key simulation.

In a preferred embodiment of the claimed invention, the mouse simulation is pressing a left button of mouse one time, pressing the left button of mouse twice, pressing a right button of mouse one time, pressing a middle button of mouse one time, switching to a desired window, opening a window of my computer, scrolling a horizontal scroll bar, dragging an object, scrolling a vertical scroll bar, paging up to last document, picture or frame, paging down to next document, picture or frame or switching to a window of desktop. The keyboard simulation is paging up to last document, picture or frame via a direction key of a keyboard, paging down to next document, picture or frame via the direction key of the keyboard, scrolling a horizontal scroll bar via the keyboard, scrolling a vertical scroll bar via the keyboard or switching to a window of desktop via the keyboard. The hot-key simulation is magnifying partially the document, icon or picture, rotating the document, picture or a frame or zooming the document, icon or picture.

In accordance with the claimed invention, the operating method of a touchpad module which is capable of interpreting multi-object gestures touches a touchpad surface by one or more than one of the conductive objects and a gesture for a detecting element to sense an object amount and the gesture and for a processing element to interpret and drive a corresponding simulation which is a browse simulation and a hot-key simulation. The processing element interprets and drives the browse simulation if the object amount is two and the hot-key simulation if the object amount is three.

In a preferred embodiment of the claimed invention, the browse simulation is selecting the document, icon, picture or frame, magnifying partially the document, icon or picture, rotating the document, picture or frame, zooming the document, icon or picture or scrolling a scroll bar. The hot-key simulation is popping up a menu, switching to a desired window, opening a window of my computer, switching to a window of desktop and paging.

It is an advantage of the present invention that the touchpad and the operating method thereof detect and interpret multi-object gestures so that it may simulate the input operation with the input devices such as a mouse and a keyboard and the selection of hot-key functions provided by various application programs.

For further understanding of these and other objectives, the nature and advantages of the invention, reference should be made to the following description taken in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a block diagram of an embodiment of a touchpad module which is capable of interpreting multi-object gestures according to the present invention.

FIG. 2 is a schematic diagram of the first embodiment of the steps and corresponding displayed content of an operating method of a touchpad module which is capable of interpreting multi-object gestures according to the present invention.

FIG. 3 is a schematic diagram of the second embodiment of the steps and corresponding displayed content of an operating method of a touchpad module which is capable of interpreting multi-object gestures according to the present invention.

FIG. 4 is a schematic diagram of the third embodiment of the steps and corresponding displayed content of an operating method of a touchpad module which is capable of interpreting multi-object gestures according to the present invention.

FIG. 5 is a schematic diagram of the fourth embodiment of the steps and corresponding displayed content of an operating method of a touchpad module which is capable of interpreting multi-object gestures according to the present invention.

FIG. 6 is a schematic diagram of the fifth embodiment of the steps and corresponding displayed content of an operating method of a touchpad module which is capable of interpreting multi-object gestures according to the present invention.

FIG. 7 is a schematic diagram of the sixth embodiment of the steps and corresponding displayed content of an operating method of a touchpad module which is capable of interpreting multi-object gestures according to the present invention.

FIG. 8 is a schematic diagram of the seventh embodiment of the steps and corresponding displayed content of an operating method of a touchpad module which is capable of interpreting multi-object gestures according to the present invention.

FIG. 9 is a schematic diagram of the eighth embodiment of the steps and corresponding displayed content of an operating method of a touchpad module which is capable of interpreting multi-object gestures according to the present invention.

### DETAILED DESCRIPTION

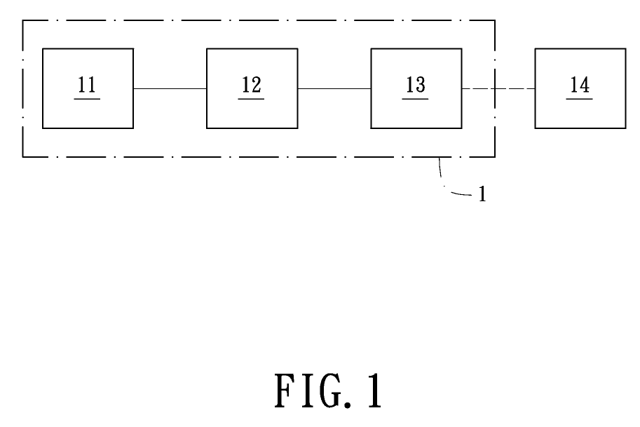

Please refer to FIG. 1 indicating an embodiment of a touchpad module which is capable of interpreting multi-object gestures according to the present invention. An user touches a touchpad surface 11 of a touchpad module 1 by one or more than one conductive object such as finger (not shown), a detecting element 12 detects an object amount such as one, two or more than two fingers or a palm of hand and a gesture such as tapping, moving or covering of the touchpad surface 11, and a processing element 13 for interpreting and driving a corresponding simulation such as mouse, keyboard or hot-key simulation according to the object amount and the gesture to control a change such as zooming, rotating and paging of a document, icon, picture or frame displayed on a display 14.

Moreover, the present invention substitutes as mouse, keyboard or various hot-keys provided in ordinary text processing application program such as Microsoft Word, Window browser such as Internet Explore or Viewer such as ACDsee or Adobe Acobat Reader. Accordingly, in this embodiment, the mouse simulation may be pressing a left, a right or a middle button of mouse one time, switching to a desired window, opening a window of my computer, paging up to last document, picture or frame, paging down to next document, picture or frame or switching to a window of desktop. The keyboard simulation may be paging up to last document, picture or frame via a direction key of a keyboard, paging down to next document, picture or frame via the direction key of the keyboard or switching to a window of desktop via the keyboard. The hot-key simulation may be magnifying partially the document, icon or picture, rotating the document, picture or a frame or zooming the document, icon or picture.

In addition, the object amount is one or more than one and the gesture includes of tapping the touchpad surface by one or more than one conductive objects one time simultaneously, if the mouse simulation is pressing a left, a right or a middle button of mouse one time. Generally, pressing the right button of mouse one time popped up a menu on a screen of a display. The object amount is three and the gesture includes of touching the touchpad surface, moving in a negative Y direction of two-dimension coordinates till a window having window icons is popped up, sliding for searching the desired window icon of the window having window icons in a positive or a negative X direction of two-dimension coordinates by any one or all of the three conductive objects simultaneously and then lifting when finding the desired window icon, if the mouse simulation is switching to a desired window. The object amount is three and the gesture includes of touching the touchpad surface simultaneously and moving in a positive Y direction of two-dimension coordinates till a disk or folder icon is displayed, if the mouse simulation is opening a window of my computer. The object amount is three and the gesture includes of touching the touchpad surface, moving in a negative X direction or moving in the negative X direction and then lifting simultaneously, if the mouse simulation is paging up to last document, picture or frame. The object amount is three and the gesture includes of touching the touchpad surface, moving in a positive X direction or moving in the positive X direction and then lifting simultaneously, if the mouse simulation is paging down to next document, picture or frame. The object amount is sufficient to cover the area consisting of two third of X traces and thee fourth of Y traces of the touchpad module at the same time, the gesture includes of touching the touchpad surface by the conductive object or the conductive objects, and the conductive object comprises a palm of a hand, if the mouse simulation is switching to a window of desktop.

In addition, the object amount is three and the gesture includes of touching the touchpad surface, moving in a negative X direction or moving in the negative X direction and then lifting simultaneously, if the keyboard simulation is paging up to last document, picture or frame via direction key of a keyboard. The object amount is three and the gesture includes of touching the touchpad surface, moving in a positive X direction or moving in the positive X direction and then lifting simultaneously, if the keyboard simulation is paging down to next document, picture or frame via direction key of the keyboard. The object amount is sufficient to cover the area consisting of two third of X traces and thee fourth of Y traces of the touchpad module at the same time, the gesture includes of touching the touchpad surface by the conductive object or the conductive objects, and the conductive object comprises a palm of a hand, if the keyboard simulation is switching to a window of desktop via the keyboard.

Furthermore, the object amount touched the touchpad surface is one, two and one in turn and the gesture includes of touching and staying at the touchpad surface by one conductive object, tapping the touchpad surface twice by the other conductive object to enable a magnifying glass, and then moving the magnifying glass to the document, icon or picture to be magnified by one of the conductive objects or disable the magnifying glass by tapping one of the conductive objects one time after the magnifying glass is displayed, if the hot-key simulation is magnifying partially the document, icon or picture. The object amount is two and the gesture includes of touching the touchpad surface by the conductive objects simultaneously, and then pivot circularly moving one conductive object in a clockwise or a counterclockwise direction on the other conductive object or pivot circularly moving two conductive objects on a midpoint of a virtual line of the two conductive objects, if the hot-key simulation is rotating the document, picture or frame. The object amount is two and the gesture includes of touching the touchpad surface by the conductive objects simultaneously, and then moving one conductive object in an outward or a toward direction to the other conductive object or the outward or the toward direction to each other, if the hot-key simulation is zooming the document, icon or picture.

One embodiment of an operating method of a touchpad module which is capable of interpreting multi-object gestures of the present invention is applied to control a change of a document, icon, picture or frame displayed on a display. The operating method includes the step of touching a touchpad surface by a conductive object or a plurality of conductive objects and a gesture for a detecting element to detect an object amount and the gesture and for a processing element to interpret and drive a corresponding simulation which is a browse simulation or a hot-key simulation. The processing element interprets and drives the browse simulation if the object amount is two and the hot-key simulation if the object amount is three. The conductive object is a finger or an object with conductive feature, for example. The browse simulation is magnifying partially the document, icon or picture, rotating the document, picture or frame and zooming the document, icon or picture. The hot-key simulation is switching to a desired window, opening a window of my computer, switching to a window of desktop and paging.

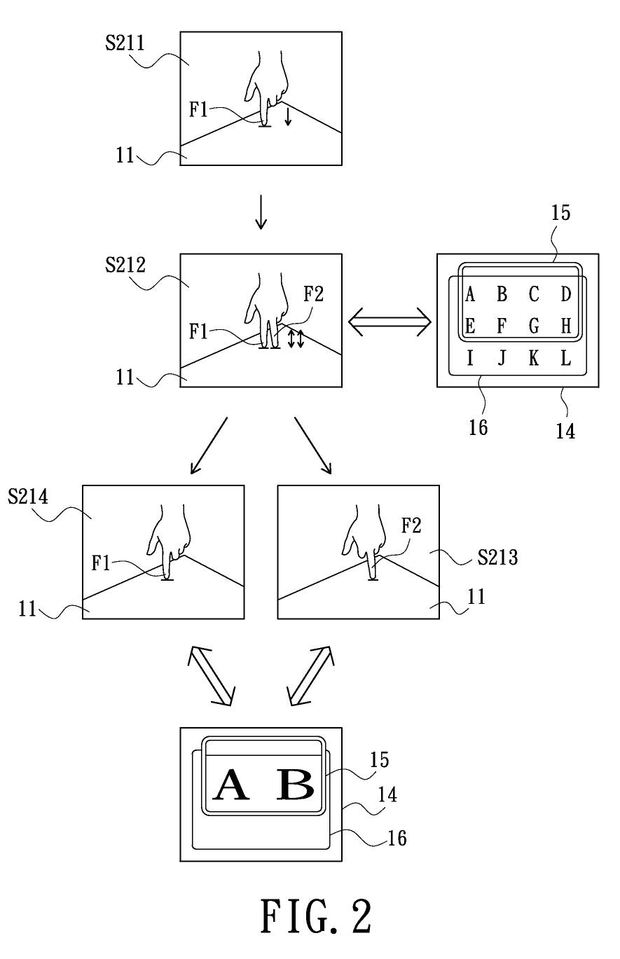

Please refer to FIG. 2 indicating the first embodiment of the steps and corresponding displayed content of an operating method of a touchpad module which is capable of interpreting multi-object gestures according to the present invention. In this embodiment, the finger F1 touches and stayed at the touchpad surface 11 in step S211, the finger F2 tapped the touchpad surface 11 twice to enable a magnifying glass 15 to be displayed on the display 14 in step S212, and then the fingers F1 or F2 moves the magnifying glass 15 to the document to be magnified 16 in step S213 or 214 respectively. Accordingly, the detecting element detects the object amount and the gesture and the processing element interprets and drives a magnifying partially the document, icon or picture of the browse simulation.

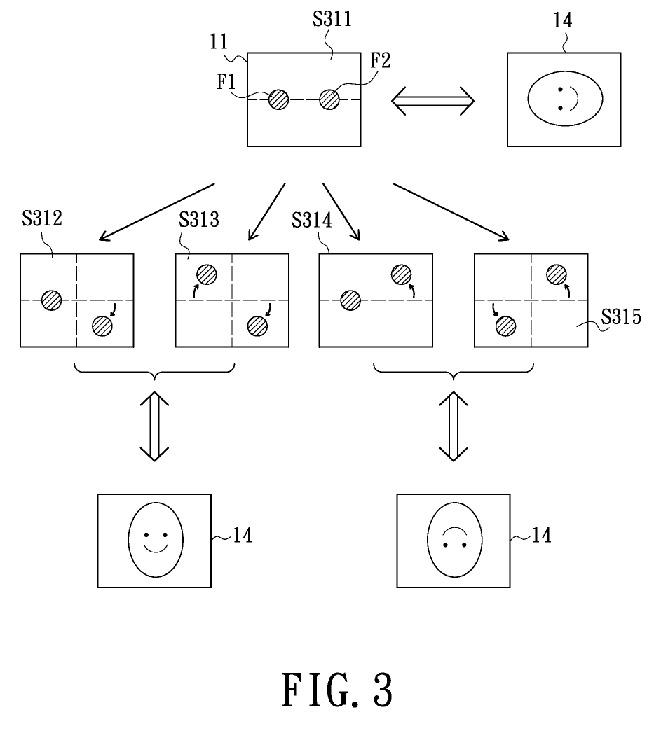

Please refer to FIG. 3 indicating the second embodiment of the steps and corresponding displayed content of an operating method of a touchpad module which is capable of interpreting multi-object gestures according to the present invention. It is noted that each circle shown indicates the sectional view of a finger, and the horizontal and the vertical dashed line indicates the baseline for illustrating the position change and moving direction of the fingers. In this embodiment, the fingers F1 and F2 touch the touchpad surface 11 simultaneously in step S311, and then the finger F2 pivot circularly moves in a clockwise direction on the finger F1 in step S312 or the fingers F1 and F2 move pivot circularly on a midpoint of a virtual line of them in the clockwise direction in step S313 so that the picture displayed is rotated to 90 degrees in the clockwise direction. Alternatively, the finger F1 pivot circularly moves in a counterclockwise direction on the finger F2 in step S314 or the fingers F1 and F2 move pivot circularly on the midpoint of the virtual line of them in the counterclockwise direction in step S315 so that the picture displayed is rotated to 90 degrees in the counterclockwise direction. It is noted that any one of the fingers F1 and F2 may be taken as a pivot. Accordingly, the detecting element detects the object amount and the gesture and the processing element interprets and drives a rotating the document, picture or frame of the browse simulation.

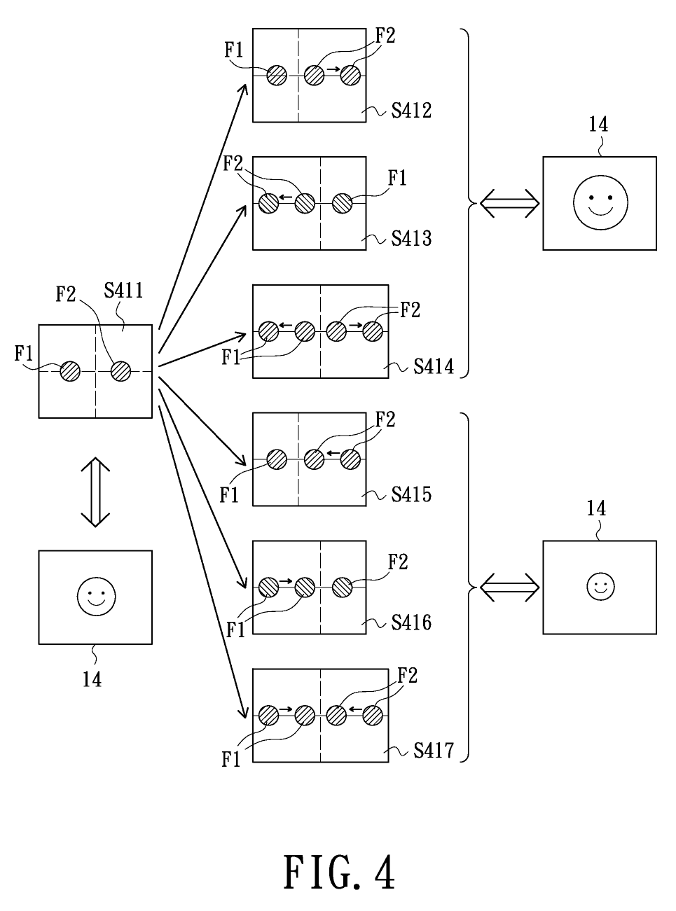

Please refer to FIG. 4 indicating the third embodiment of the steps and corresponding displayed content of an operating method of a touchpad module which is capable of interpreting multi-object gestures according to the present invention. Similarly, each circle shown indicates the sectional view of a finger, and the horizontal and the vertical dashed line indicates the baseline for illustrating the position change and moving direction of the fingers. In this embodiment, the fingers F1 and F2 touch the touchpad surface 11 simultaneously in step S411, and then the finger F2 moves in an outward direction to the finger F1 in step S412, the finger F1 moves in the outward direction to the finger F2 in step S413 or the fingers F1 and F2 moves outward to each other in step S414 so that the picture displayed on the display 14 is zoomed out. Alternatively, after performing the step S411, the finger F2 moves in a toward direction to the finger F1 in step S415, the finger F1 moves in the toward direction to the finger F2 in step S416 or the fingers F1 and F2 moves toward to each other in step S417 so that the picture displayed on the display 14 is zoomed in. Accordingly, the detecting element detects the object amount and the gesture and the processing element interprets and drives a zooming the document, icon or picture of the browse simulation.

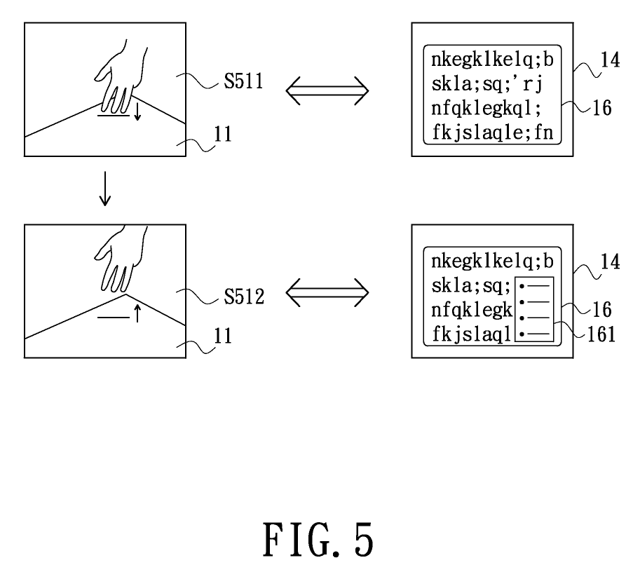

Please refer to FIG. 5 indicating the fourth embodiment of the steps and corresponding displayed content of an operating method of a touchpad module which is capable of interpreting multi-object gestures according to the present invention. In this embodiment, the fingers F1, F2 and F3 tapped the touchpad surface 11 one time simultaneously in step S511 and then lift the touchpad surface 11 simultaneously in step S512, and accordingly the detecting element detects the object amount and the gesture and the processing element interprets and drives a popping up a menu of the hot-key simulation. Therefore, the document 16 displayed on the display 14 is partially overlapped by a menu 161.

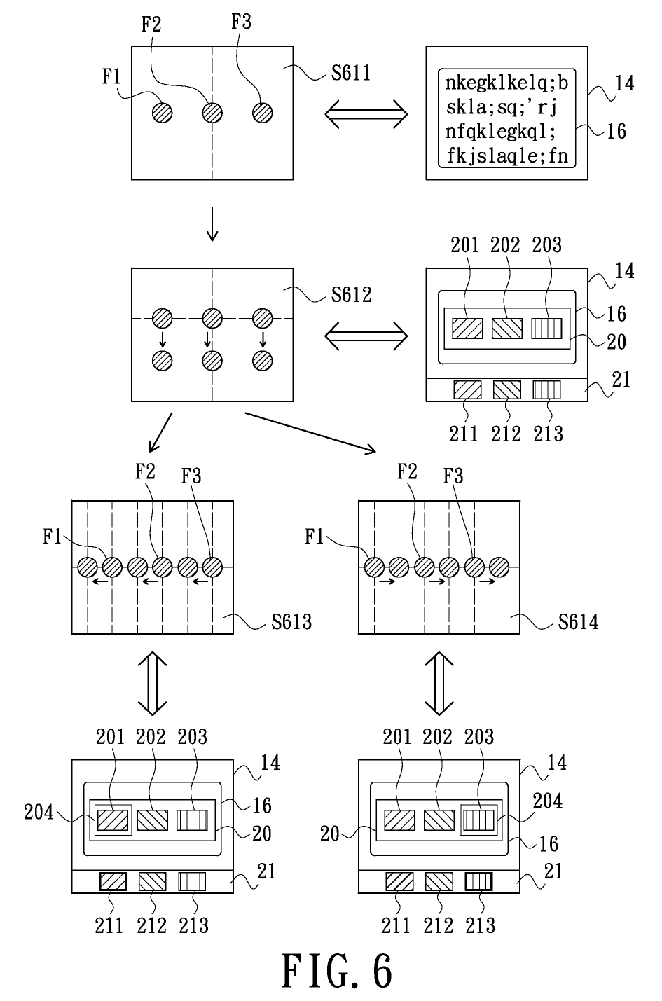

Please refer to FIG. 6 indicating the fifth embodiment of the steps and corresponding displayed content of an operating method of a touchpad module which is capable of interpreting multi-object gestures according to the present invention. Similarly, each circle shown indicates the sectional view of a finger, and the horizontal and the vertical dashed line indicates the baseline for illustrating the position change and moving direction of the fingers. In this embodiment, the fingers F1, F2 and F3 touch the touchpad surface 11 simultaneously in step S611, moves in a negative Y direction of two-dimension coordinates till a window 20 having window icons 201, 202 and 203 in accordance to the window icons 211, 212 and 213 in the toolbar 21 is overlapped on the document 16 displayed on the display 14 in step S612, and then slides for searching a desired window icon indicated by the rectangular frame 204 of the window 20 in a positive or a negative X direction simultaneously in step S613 or S614. Accordingly, the desired window icons 201 and 203 of in accordance with the step S613 and S614 are mapped to the window icons 211 and 213 in the toolbar 21, and thus the detecting element detects the object amount and the gesture and the processing element interprets and drives a switching to a desired window of the hot-key simulation.

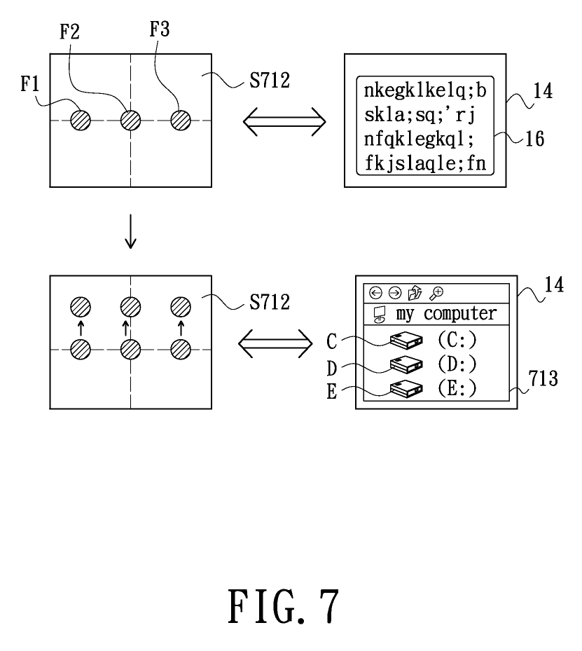

Please refer to FIG. 7 indicating the sixth embodiment of the steps and corresponding displayed content of an operating method of a touchpad module which is capable of interpreting multi-object gestures according to the present invention. Similarly, each circle shown indicates the sectional view of a finger, and the horizontal and the vertical dashed line indicates the baseline for illustrating the position change and moving direction of the fingers. In this embodiment, the fingers F1, F2 and F3 touch the touchpad surface 11 simultaneously in step S711 and moves in a positive Y direction of two-dimension coordinates simultaneously till a window 713 having disk C, D and E switching from a window 16 is displayed on the display 14 in step S712. Accordingly, the detecting element detects the object amount and the gesture and the processing element interprets and drives an opening a window of my computer of the hot-key simulation.

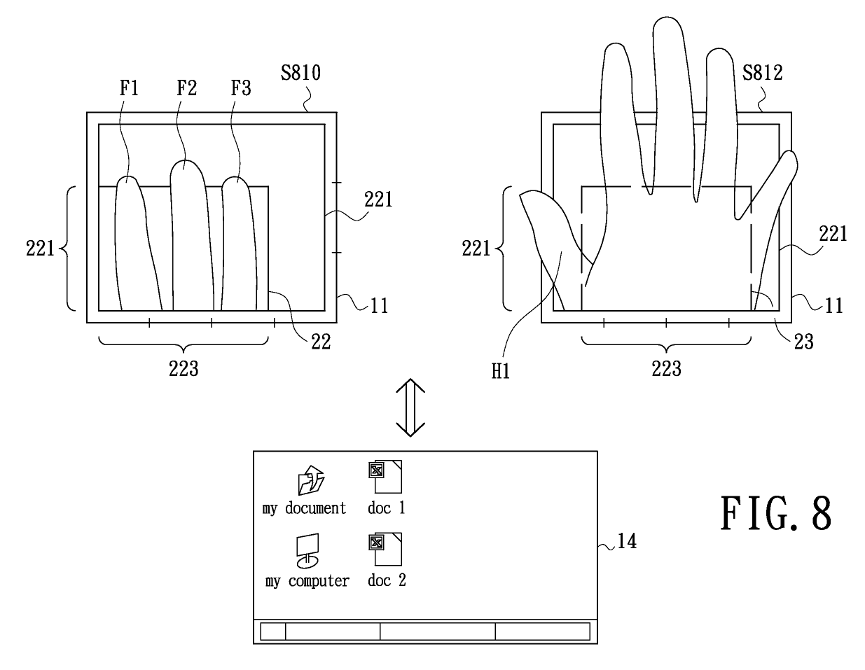

Please refer to FIG. 8 indicating the seventh embodiment of the steps and corresponding displayed content of an operating method of a touchpad module which is capable of interpreting multi-object gestures according to the present invention. In this embodiment, the fingers F1, F2 and F3 touch to cover an active detecting area 22 consisting of two third of X traces indicted by a width 221 and thee fourth of Y traces indicted by a width 223 of the touchpad surface 11 simultaneously in step S810, or a palm of hand H1 touches to cover an active detecting area 23 consisting of two third of X traces indicted by the width 221 and thee fourth of Y traces indicted by the width 223 of the touchpad surface 11 in step S812. Accordingly, the detecting element detects the object amount and the gesture and the processing element interprets and drives a switching to a window of desktop, which has the icons “my document”, “my computer”, “doc 1” and “doc 2” displayed on the display 14, of the hot-key simulation.

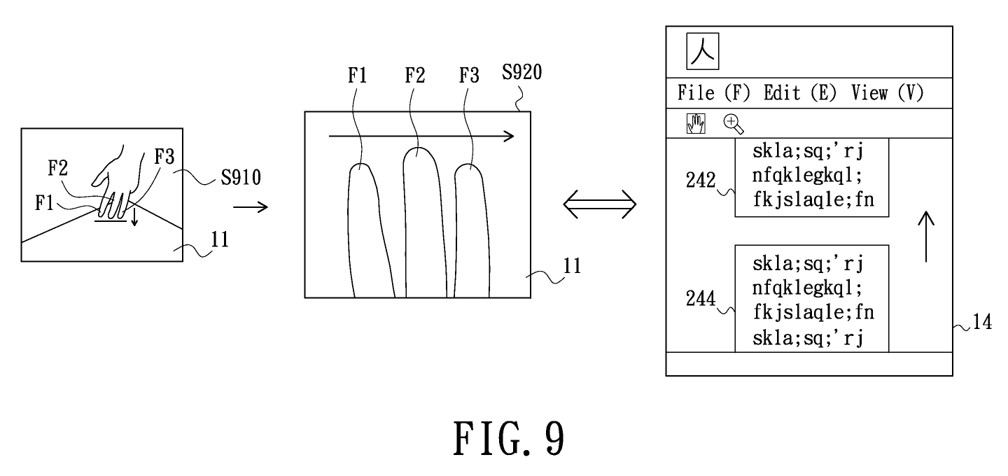

Please refer to FIG. 9 indicating the eighth embodiment of the steps and corresponding displayed content of an operating method of a touchpad module which is capable of interpreting multi-object gestures according to the present invention. As shown in the FIG. 9, the fingers F1, F2 and F3 touch the touchpad surface 11 simultaneously in step S910 and move in a positive X and then lift simultaneously in step S920 so that the page 242 having format pdf displayed on the display 14 is paged upward for displaying the next page 244, and accordingly the detecting element detects the object amount and the gesture and the processing element interprets and drives a paging of the hot-key simulation. Similarly, in an alternative embodiment, the fingers F1, F2 and F3 touch the touchpad surface 11 simultaneously, move in a negative X and then lift simultaneously so that the page 242 having format pdf displayed is paged downward for displaying the previous page, and accordingly the detecting element detects the object amount and the gesture and the processing element interprets and drives a paging of the hot-key simulation. Moreover, the paging of the hot-key simulation switched a web page to a previous page and a next page in Internet browser environment.

Accordingly, the touchpad including a detecting element and a processing element and the operating method of the present invention may detect and interpret the multi-object gestures to simulate the input operations to the input devices such as a mouse and a keyboard and the hot-key functions provided by various application programs, and thus users may operate the touchpad module and control the content displayed more straightforward.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

1. A touchpad module which is capable of interpreting multi-object gestures, comprising:
a detecting element for detecting an object amount and a gesture made from a conductive object placed on a touchpad surface; and
a processing element for interpreting and driving a corresponding simulation according to the object amount and the gesture to control a change of a document, icon, picture or frame displayed on a display, wherein the corresponding simulation is a mouse simulation, a keyboard simulation or a hot-key simulation.

2. The touchpad module which is capable of interpreting multi-object gestures of claim 1, wherein the object amount is one or more than one and the gesture comprises of tapping the touchpad surface by one or more than one of the conductive objects one time simultaneously, if the mouse simulation is pressing a left-, a right or a middle button of mouse one time.

3. (canceled)

4. The touchpad module which is capable of interpreting multi-object gestures of claim 1, wherein the object amount is three and the gesture comprises of touching the touchpad surface, moving in a negative Y direction of two-dimension coordinates till a window having window icons is popped up, sliding for searching the desired window icon of the window having window icons in a positive or a negative X direction of two-dimension coordinates by any one or all of the three conductive objects simultaneously and then lifting when finding the desired window icon, if the mouse simulation is switching to a desired window.

5. The touchpad module which is capable of interpreting multi-object gestures of claim 1, wherein the object amount is three and the gesture comprises of touching the touchpad surface simultaneously and moving in a positive Y direction of two-dimension coordinates till a disk or folder icon is displayed, if the mouse simulation is opening a window of my computer.

6. The touchpad module which is capable of interpreting multi-object gestures of claim 1, wherein the object amount is three and the gesture comprises of touching the touchpad surface, moving in a negative X direction or moving in the negative X direction and then lifting simultaneously, if the mouse simulation is paging up to last document, picture or frame.

7. The touchpad module which is capable of interpreting multi-object gestures of claim 1, wherein the object amount is three and the gesture comprises of touching the touchpad surface, moving in a positive X direction or moving in the positive X direction and then lifting simultaneously, if the mouse simulation is paging down to next document, picture or frame.

8. The touchpad module which is capable of interpreting multi-object gestures of claim 1, wherein the object amount is sufficient to cover the area consisting of two third of X traces and thee fourth of Y traces of the touchpad module at the same time, the gesture comprises of touching the touchpad surface by the conductive object or the conductive objects, and the conductive object comprises a palm of a hand, if the mouse simulation is switching to a window of desktop.

9. The touchpad module which is capable of interpreting multi-object gestures of claim 1, wherein the object amount is three and the gesture comprises of touching the touchpad surface, moving in a negative X direction or moving in the negative X direction and then lifting simultaneously, if the keyboard simulation is paging up to last document, picture or frame via direction key of a keyboard.

10. The touchpad module which is capable of interpreting multi-object gestures of claim 1, wherein the object amount is three and the gesture comprises of touching the touchpad surface, moving in a positive X direction or moving in the positive X direction and then lifting simultaneously, if the keyboard simulation is paging down to next document, picture or frame via direction key of a keyboard.

11. The touchpad module which is capable of interpreting multi-object gestures of claim 1, wherein the object amount is sufficient to cover the area consisting of two third of X traces and thee fourth of Y traces of the touchpad module at the same time, the gesture comprises of touching the touchpad surface by the conductive objects, and the conductive object comprises a palm of a hand, if the keyboard simulation is switching to a window of desktop via a keyboard.

12. The touchpad module which is capable of interpreting multi-object gestures of claim 1, wherein the object amount touched the touchpad surface is one, two and one in turn and the gesture comprises of touching and staying at the touchpad surface by one conductive object, tapping the touchpad surface twice by the other conductive object to enable a magnifying glass, and then moving the magnifying glass to the document, icon or picture to be magnified by one of the conductive objects or disable the magnifying glass by tapping one of the conductive objects one time after the magnifying glass is displayed, if the hot-key simulation is magnifying partially the document, icon or picture.

13. The touchpad module which is capable of interpreting multi-object gestures of claim 1, wherein the object amount is two and the gesture comprises of touching the touchpad surface by the conductive objects simultaneously, and then pivot circularly moving one conductive object in a clockwise or a counterclockwise direction on the other conductive object or pivot circularly moving two conductive objects on a midpoint of a virtual line of the two conductive objects, if the hot-key simulation is rotating the document, picture or frame.

14. The touchpad module which is capable of interpreting multi-object gestures of claim 1, wherein the object amount is two and the gesture comprises of touching the touchpad surface by the conductive objects simultaneously, and then moving one conductive object in an outward or a toward direction to the other conductive object or the outward or the toward direction to each other, if the hot-key simulation is a zooming the document, icon or picture.

15. An operating method of a touchpad module which is capable of interpreting multi-object gestures for controlling a change of a document, icon, picture or frame displayed on a display comprising:
touching a touchpad surface by a conductive object or a plurality of conductive objects and a gesture for a detecting element to detect an object amount and the gesture and for a processing element to interpret and drive a corresponding simulation, wherein the corresponding simulation is a browse simulation and a hot-key simulation, the processing element interprets and drives the browse simulation if the object amount is two, and the processing element interprets and drives the hot-key simulation if the object amount is three.

16. The operating method of a touchpad module which is capable of interpreting multi-object gestures of claim 16, wherein the gesture comprises of touching and staying at the touchpad surface by one of the conductive objects, tapping the touchpad surface twice by the other one of conductive objects to enable a magnifying glass, and then moving the magnifying glass to the document, icon or picture to be magnified by one of the conductive objects after the magnifying glass is displayed, if the browse simulation is magnifying partially the document, icon or picture.

17. The operating method of a touchpad module which is capable of interpreting multi-object gestures of claim 15, wherein the gesture comprises of touching the touchpad surface by the conductive objects simultaneously, and then pivot circularly moving one of the conductive objects in a clockwise or a counterclockwise direction on the other one of conductive objects or pivot circularly moving the conductive objects on a midpoint of a virtual line of the conductive objects, if the browse simulation is rotating the document, picture or frame.

18. The operating method of a touchpad module which is capable of interpreting multi-object gestures of claim 15, wherein the gesture comprises of touching the touchpad surface by the conductive objects simultaneously, and then moving one of the conductive objects in an outward or a toward direction to the other one of the conductive objects or the outward or the toward direction to each other, if the browse simulation is zooming the document, icon or picture.

19. The operating method of a touchpad module which is capable of interpreting multi-object gestures of claim 15, wherein the gesture comprises of touching the touchpad surface, moving in a negative Y direction of two-dimension coordinates till a window having multiple window icons is displayed, and then sliding for searching a desired window icon of the window having window icons in a positive or a negative X direction of two-dimension coordinates by the conductive objects simultaneously, if the hot-key simulation is switching to a desired window.

20. The operating method of a touchpad module which is capable of interpreting multi-object gestures of claim 15, wherein the gesture comprises of touching the touchpad surface simultaneously and moving in a positive Y direction of two-dimension coordinates, if the hot-key simulation is opening a window of my computer.

21. The operating method of a touchpad module which is capable of interpreting multi-object gestures of claim 15, wherein the gesture comprises of touching the touchpad surface by sufficient amount of the conductive objects to cover the area consisting of two third of X traces and thee fourth of Y traces of the touchpad module at the same time, and the conductive object comprises a palm of a hand, if the hot-key simulation is switching to a window of desktop.

22. The operating method of a touchpad module which is capable of interpreting multi-object gestures of claim 15, wherein the gesture comprises of touching the touchpad surface, moving in a positive X or a negative direction or lifting after moving in the positive or the negative X direction simultaneously, if the hot-key simulation is paging.
